(19) United States
(12) Patent Application Publication
(10) Pub. No.: US 2005/0206724 A1
(43) Pub. Date: Sep. 22, 2005

(54) Device to position liquid crystal panels in a color liquid crystal projector

(75) Inventor: Alois Dehlink, Voesendorf (AT)

Correspondence Address: PHILIPS INTELLECTUAL PROPERTY & STANDARDS, P.O. BOX 3001, BRIARCLIFF MANOR, NY, 10510, US

(73) Assignee: Koninkijke Philips Electronics N.V.

(21) Appl. No.: 10/517,476

(22) PCT Filed: May 30, 2003
(86) PCT No.: PCT/IB03/02365

§ 371 Date: Dec. 7, 2004

(30) Foreign Application Priority Data
Jun. 10, 2002 (EP) 02100685.3

(51) Int. Cl. H04N 9/47

(52) U.S. Cl. 348/92; 348/135

(57) ABSTRACT

In a positioning device (18) to position displays (9, 12, 14) of a projector (1), test image information (P-BI) is obtained by means of four telescopes (T), the information being evaluated manually by an operator or also automatically by feedback control means for the positioning of the displays (9, 12, 14).

The invention relates to a positioning device to position at least a first display of a hardware unit, which can be lit by a first color beam, in relation to at least one other optically active element of the hardware unit, in order to project the image generated by at least one display by projecting a projection beam that can be emitted by the hardware unit in a plane of projection, having
holding means for holding at least the first display during a positioning operation and a subsequent operation to fix the positioned display, and having
optical means to which the projection beam can be delivered and which are designed to emit test image information suitable for assessing the positioning of the display, and having
control means for controlling the holding means in order to adjust the position of the first display in relation to the other optically active elements during the positioning operation, and having
fixing means for permanently fixing the positioned first display during the fixing operation.

The invention further relates to a positioning method for the positioning of at least one first display of a hardware unit, which can be lit by a first color beam, in relation to at least one other optically active element of the hardware unit, in order to project the image generated by at least one display by projecting a projection beam that can be emitted by the hardware unit in a plane of projection, the said method involving the following stages:
holding at least the first display during a positioning operation and a subsequent operation to fix the positioned display;
delivery of the projection beam to optical means which emit test-image information suitable for assessing the positioning of the display;
controlling the holding means, in order to adjust the position of the first display in relation to the other optically active elements during the positioning operation;
permanent fixing of the positioned first display during the fixing operation.

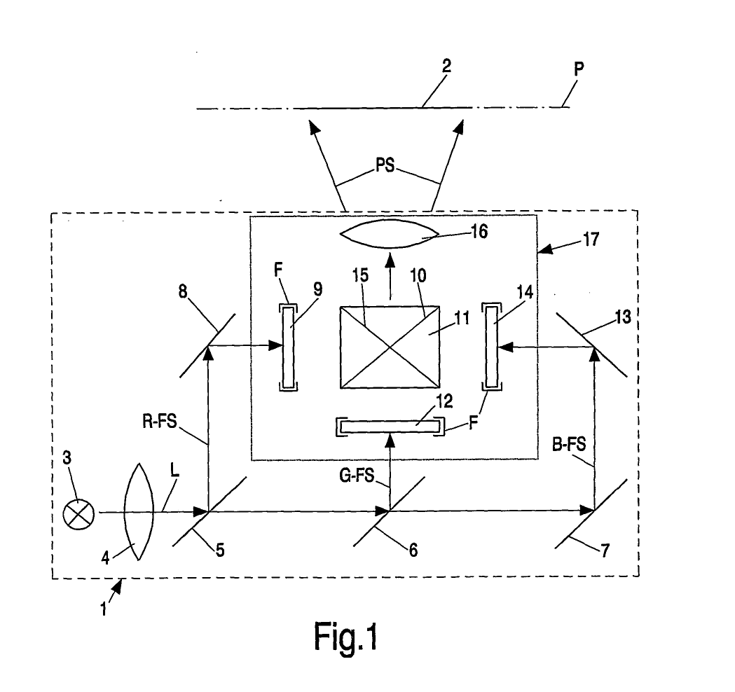

Such a positioning device and such a positioning method are known from a commercially available positioning table made by Messrs. M-Tech for the manufacture of hardware units for projectors. With such a projector it is possible to project the image information of a television signal or monitor signal on a projection screen in a plane of projection for a user. The basic construction of such as projector is represented in FIG. 1. White light is split up by two color splitters into a red color beam, a green color beam and a blue color beam. The three color beams each light a display, each display representing the respective color fraction of the total image. In a recombination prism the three color beams are combined into a projection beam, which is projected in the plane of projection by means of a hardware optics. The three displays, the recombination prism and the hardware optics here form a so-called hardware unit.

In order to be able to project a sharp image in the plane of projection using the projector, it is particularly important that the three displays are positioned very accurately in their position in relation to one another and in relation to the recombination prism and the hardware optics. If this is not the case, the pixels of the display reproducing the red image information will not be projected congruently with the pixels of the display reproducing the green image information and the latter will not be projected congruently with the pixels of the display reproducing the blue image information. The known positioning table is used for positioning the displays in the manufacture of the hardware unit. The housing of the hardware unit and ready assembled recombination prism and hardware optics are placed on the positioning table. In a loading operation, an operator introduces the three displays into holding means of the positioning table. The holding means take the form of a mechanical holding device, in which each display is held separately and by means of which the position of the displays in relation to one another and to the recombination prism and the hardware optics can be adjusted.

In the known positioning table four video cameras are furthermore provided in the plane of projection, one video camera in each case recording the pixels of the image projected into one of the four corners. Test-image information recorded by the video cameras is represented on four monitors for the operator of the positioning table. By operating switches of the positioning table control means, the operator can deliver control information to the holding device, in order to adjust the position of the displays. By observing the test image information and entering suitable control information, the operator during a positioning operation can set the optimum position of the three displays, in order to obtain congruent test image information of the three displays. In a subsequent fixing operation the positioned displays are fixed in their position and the hardware unit then removed from the positioning table.

Since air included in the hardware unit must contain as little dust as possible, in order to allow the finished projector to project an image undistorted by dust particles, the positioning table must be provided in a so-called clean room. A clean room has a plurality of filter systems and other technical aids and is very expensive to produce and operate. In order not to take up too much space with the positioning table in the clean room, the known positioning table has a deflecting mirror for deflecting the projection beam.

In the known projection table, the fact that the deflecting mirror represents an additional source of error and an additional interference factor in the positioning of the displays and the assessment of the test image information, has proved disadvantageous. For example, vibrations of the deflecting mirror, which are very disruptive in assessing the test image information represented by the monitors, can occur during the positioning operation. The fact that the positioning device, despite the deflecting mirror, still takes up a relatively large amount of space in the clean room, has proved to be a further disadvantage of the known positioning device.

The object of the invention is to create a positioning device of the generic type specified in the first paragraph and a positioning method of the generic type specified in the second paragraph, in which the aforementioned disadvantages are avoided. This object is achieved in that the optical means in such a positioning device contain at least a first telescopic optical system, which is designed to focus on individual pixels in the first display.

The aforementioned object is achieved in such a positioning method in that the projection beam is delivered to at least one telescopic optical system, which is designed to focus on individual pixels in the first display and which emits test image information suitable for assessing the positioning of the display.

The features according to the invention ensure that the pixels of the display itself and not the image of the pixels projected in the plane of projection are examined as test image information by the operator using at least one telescopic optical system. This affords the advantage, that during the positioning operation it is possible to dispense entirely with a projection of the image in the plane of projection. It is therefore possible to substantially reduce the dimensions of the positioning device according to the invention compared to the known positioning device, and thereby to make significant cost savings in the design dimensions of the clean room. In addition, the omission of the deflecting mirror means that substantially more accurate and reliable test image information is obtained, which ultimately has a positive effect in improved positioning of the displays in the hardware unit. The projectors manufactured using the positioning device according to the invention have a substantially improved definition of the projected image information.

The measures as claimed in claim 2 afford the advantage that the positioning device can also be used for the manufacture of hardware units in which the image information to be projected is split between two or more (typically three) displays.

The measures as claimed in claim 3 afford the advantage that the pixels of each corner of at least two displays are each observed by means of a telescope, so that any tiltings of the displays relative to one another can be precisely determined. It should be mentioned here that just three telescopes would suffice for accurate positioning of the displays and that provision of the fourth telescope advantageously affords a control facility.

The known positioning table has a mercury vapor lamp (UHP lamp) for generating the color beams. This very powerful light source is necessary for projecting the image information on to the projection screen. The use of the UHP lamp gives rise to heat problems on the positioning table and in the clean room, since the fine adjustment of the displays in the order of a few microns during the positioning operation is sensitive to temperature fluctuations. The use of telescopes makes it possible to dispense with the projection of image information, the measures as claimed in claim 4 affording the advantage that at least one LED can be used as means of illumination for generating the color beams. This relatively weak light source does not give rise to any heat problems, which is very advantageous.

The measures as claimed in claim 5 and claim 10 afford the advantage that in the loading operation the operator can easily insert the displays in the holding means, the display being brought into a starting position for the subsequent positioning operation. The ease of loading the displays affords the advantage that very swift insertion is possible and a larger number of hardware units can therefore be manufactured per unit time.

In the known positioning table the fact that rotation of the display about one spatial axis at the same time causes a displacement of the display along the other two spatial axes, has proved disadvantageous. These measures as claimed in claim 6 and claim 11 afford the advantage that this displacement is automatically compensated for, thereby making the positioning operation significantly easier for the operator. The measures also mean that a greater number of hardware units can be manufactured per unit time, which is very advantageous.

The measures as claimed in claim 7 afford the advantage that the positioning operation is fully automated and an operator can therefore also operate two or more positioning devices. They also afford the additional advantage of an objective assessment of the test image information and consequently an improved positioning of the displays.

The measures as claimed in claim 8 afford the advantage that even X-prism defects of the recombination prism and other optical errors and tolerances of the hardware optics are taken into account in the positioning of the displays.

The invention will be further described with reference to examples of embodiments shown in the drawings to which, however, the invention is not restricted.

FIG. 1 shows the passage of light beams through optically active elements of a projector for projecting image information.

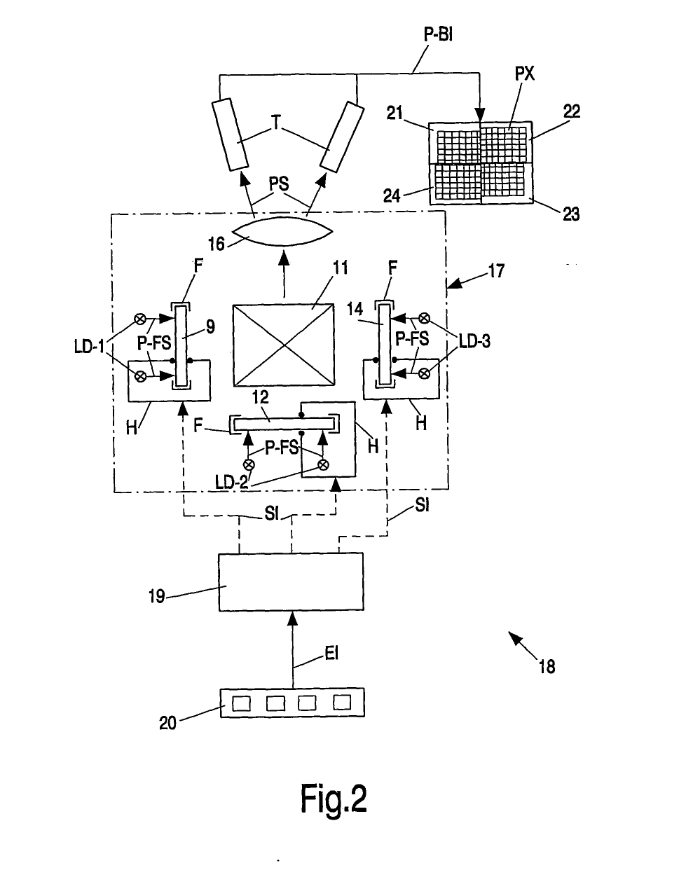

FIG. 2 shows functional blocks of a positioning device for positioning three displays in a hardware unit of the projector in the hardware unit manufacturing process, four telescopes being provided for observing the current position of the displays.

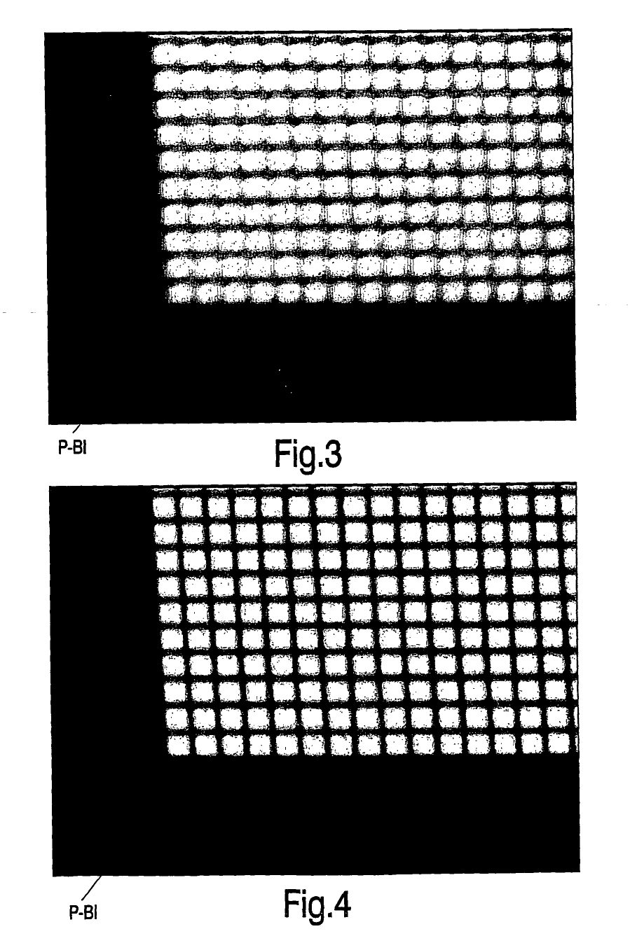

FIGS. 3 and 4 show test image information emitted by one of the telescopes of the positioning device and represented by a monitor, from which it can be determined whether the displays are already positioned.

FIG. 1 shows the passage of light beams through optically active elements of a projector 1 for projecting image information on to a projection screen 2 provided in a plane of projection P. The projector 1 contains a mercury vapor lamp 3, which in operation emits white light L towards a focusing lens 4. A first color splitter 5 is reflective to red light and emits a red color beam R-FS, whilst the residual color fraction of the white light L is incident upon a second color splitter 6. The second color splitter 6 is reflective to green light and emits a green color beam G-FS, whilst the remaining blue color fraction of the white light L is deflected by a first reflector 7 as blue color beam B-FS.

The red color beam R-FS is deflected by a second reflector 8 on to a first display 9. The first display 9 is activated in a manner not shown further FIG. 1 by the red signal fraction of the image to be projected by the projector 1. This ensures that those areas of the first display 9 representing image fractions of the image to be projected, which are intended to contain the red light, are transparent. According to the transparency of the display 9, the red color beam R-FS is capable of lighting these areas of the first display 9, with full or with reduced intensity. This fraction of the red color beams R-FS representing the red image information of the image to be projected is incident upon a first reflection surface 10 of a recombination prism 11.

The green color beam G-FS is deflected on to a second display 12 by means of the second color splitter 6. The second display 12 is activated in the manner described above by the green signal fraction of the image to be projected, so that the fraction of the green color beam G-FS representing the green image information of the image to be projected is incident upon the recombination prism 11.

The blue color beam B-FS is deflected on to a third display 14 by means of a third reflector 13. The third display 14 is activated in the manner described above by the blue signal fraction of the image to be projected, so that the fraction of the blue color beam B-FS representing the blue image information of the image to be projected is incident upon a second reflection surface 15 of the recombination prism 11.

The first reflection surface 10 is reflective to the red color beam R-FS and transparent to the green color beam G-FS and the blue color beam B-FS. The second reflection surface 15 is reflective to the blue color beam B-FS and transparent to the green color beam G-FS and the red color beam R-FS. As a result, the three color beams are recombined in the recombination prism. A projection beam PS containing all the image information of the image to be projected can be emitted by the recombination prism 11.

The projector 1 furthermore has hardware optics 16, which project the projection beam PS on to the projection screen 2, the hardware optics 16 being capable of adjusting the projected image so that it is sharp and focused. The first display 9, the second display 12, the third display 14, the recombination prism 11 and the hardware optics 16 are accommodated in an essentially dust-tight hardware unit 17. This ensures that no dust particles collect on these optically active elements, which would be projected on to the projection screen 2 in the same way as the image information of the image to be projected and would interfere with the overall visual impression.

In order to enclose as few dust particles as possible in the hardware unit 17 during manufacture of the hardware unit 17, the hardware unit 17 is assembled in a so-called clean room and sealed essentially dust-tight. A clean room has a number of filter systems and additional facilities in order to guarantee, for example, that fewer than 10000 dust particles measuring 0.5 μm or 70 dust particles measuring 5.0 μm are contained in the air of the clean room. An operator for operating a positioning device in the clean room may only enter the clean room wearing special protective clothing, in order to prevent dust particles being introduced into the clean room. For this reason a clean room is very expensive both to set up and to run.

Each of the displays 9, 12 and 14 is held in its position in the hardware unit 17 by a so-called frame F. The position of the displays 9, 12 and 14 in relation to one another and in relation to the recombination prism 11 and the hardware optics 16 is crucial in determining whether the projector 1 is capable of projecting clear, sharp images. If one or more of the displays 9, 12, and 14 is not correctly positioned, the partial images containing the red, the green and the blue image information will not be projected precisely overlapping on the projection screen 2. If the hardware optics 16 are not correctly positioned, the projected image cannot be sharply adjusted or distortions of the projected image can occur. In order to position the displays 9, 12 and 14 precisely during manufacture, a positioning device 18 provided in the clean room is used, the working principle of which is explained in more detail with reference to FIG. 2.

FIG. 2 shows the hardware unit 17, the optically active elements of which have been described above. For each display 9, 12 and 14 to be positioned, the positioning device 18 has four LEDs LD-1, LD-2, LD-3, which are arranged in the four corners of the displays 9, 12 and 14 and are designed to emit a test color beam P-FS. The heat generated on the positioning device 18 by the LEDs LD-1, LD-2 LD-3 during a positioning operation is negligible, so that advantageously no heat problems occur during the positioning operation.

The positioning device 18 furthermore has holding means H for each display 9, 12 and 14 for holding the displays 9, 12 and 14 during the positioning operation and a subsequent operation to fix the positioned displays 9, 12 and 14. The holding means H are represented only symbolically in FIG. 2, but for each display 9, 12 and 14 have a loading device, into which the displays 9, 12 and 14 can easily be inserted by an operator during a loading operation. After insertion, the displays 9, 12 and 14 are pressed against three reference positions by means of two positioning pins, in order to position the displays 9, 12 and 14 in a starting position for the subsequent positioning operation.

The holding means H furthermore have three positioning tables made by Messrs. Physik Instrumente GmbH&Co.KG (type F-206), which are designed for independently adjusting the position of each of the displays 9, 12 and 14 along and about the three spatial axes. Positioning table control electronics allow any displacement along the other two spatial axes that occurs during rotation of one of the displays 9, 12 or 14 about one of the spatial axes to be automatically compensated for. This affords the advantage, that when positioning the displays 9, 12 and 14 the operator can work significantly faster and more efficiently. Another advantage is that even a still relatively inexperienced operator can undertake positioning of the displays.

The positioning device 18, in a form not further shown in FIG. 2, contains fixing means for permanently fixing the positioned displays 9, 12 and 14 in the fixing operation following the positioning operation. For this purpose adhesive is applied between the frames F, on which the displays 9, 12 and 14 are mounted, and the holders mounted on the recombination prism 11, the adhesive still being soft during the positioning operation and being set by illumination with UV light during the fixing operation. Such adhesives setting in UV light have long been known.

The positioning device 18 furthermore has control means 19 for controlling the positioning tables of the holding means H in order to adjust the position of the displays 9, 12 and 14 in relation to one another and in relation to the recombination prism 11 and the hardware optics 16 during the positioning operation. The control means 19 take the form of a computer running a corresponding software program. Via keys on a keyboard 20 the operator can deliver input information El to the control means 19, an item of control information El indicating, for example, that the first display 9 is to be displaced by +10 microns along the spatial axis X. The control means 19 detect the necessary motor control signals for the servomotor of the positioning table positioning the first display 9 and deliver corresponding control information SI an this servomotor.

The positioning device 18 now has optical means, to which the projection beam PS can be fed and which are designed to deliver test image information P-BI suitable for assessing the positioning of the displays 9, 12 and 14. The optical means here contain four telescopes T, which are so positioned that with each of the four telescopes T it is possible to focus pixels PX of the four corners of the displays 9, 12 and 14. The four telescopes T may be provided relatively close to the hardware optics 16, since no projection of the projection beam PS in the plane of projection P is necessary. This affords the great advantage that the dimensions of the projection device 18 are relatively small and the projection device 18 therefore takes up relatively little space in the clean room.

The projection device 18 furthermore has four monitors 21, 22, 23 and 24, to which the test image information P-BI can be fed. The monitor 21 can be used to represent the pixels PX of the upper left-hand corners of the three displays 9, 12 and 14. The monitor 22 can be used to represent the pixels PX of the upper right-hand corners, the monitor 23 can be used to represent the pixels PX of the bottom right-hand corners and the monitor 24 can be used to represent the pixels PX of the bottom left-hand corners of the three displays 9, 12 and 14.

The various steps in a positioning method for the positioning of the displays 9, 12 and 14 to be performed by the operator of the positioning device 18 in the manufacture of the hardware unit 17 are explained in more detail below. After an initializing operation on the positioning device 18, in which the computer of the control means 19 is switched on and the corresponding software program is started and further initializing stages are performed, the loading operation commences. In this, the operator inserts the first display 9, the second display 12 and the third display 14 into the corresponding loading devices of the holding device H. Then the further elements of the hardware unit 17 are inserted in loading devices of the positioning device 18. The operator completes the loading operation by simultaneously pressing two keys on the keyboard 20, whereupon the displays 9, 12 and 14 are positioned in the starting position by the positioning pins and then held by gripper arms of the holding means H.

In a first stage of the positioning operation, the four LEDs LD-2 lighting the second display 12 are switched on. By pressing keys on the keyboard 20 and observing the pixels PX of the second display 12 represented by the monitors 21 to 24, the operator positions the second display 12 by displacing it along two spatial axes into a nominal position. It is then examined whether the second display 12 is in a tilted position. As can be seen in FIG. 3, a tilted positioning can be recognized from the fact that the pixels PX of one or more corners of the second display 12 are shown blurred. By pressing keys on the keyboard 20 the operator rotates the second display 12 about the corresponding spatial axes until all corners of the second display 12 are sharply adjusted, as shown in FIG. 4.

In the next stage the LEDs LD-1 lighting the first display 9 are switched on and the first display 9 is positioned in the same way as explained above with reference to the positioning of the second display 12. In the following stage the third display 14 is now positioned in the same way.

In subsequent stages each of the LEDs LD-1, LD-2 and LD-3 is alternately switched on by two of the three displays 9, 12 and 14 and the pixels PX now shown overlapping by two of the displays 9, 12 and 14 in each case are positioned so that they are superimposed. In the final stage all LEDs LD-1, LD-2 and LD-3 are switched on and it is examined whether the pixels PX of all three displays 9, 12 and 14 are now positioned congruently and shown sharply defined. If necessary, the positioning of the three displays 9, 12 and 14 is rectified.

In the subsequent stages of the fixing operation the operator presses a key on the keyboard 20, whereupon a UV lamp is switched on for a predetermined length of time and the adhesive between the frames F and the holders on the recombination prism 11 is set. The hardware unit 17 with the now finally positioned displays 9, 12 and 14 is then removed from the positioning device 18.

The positioning method described above affords the advantage that all three displays 9, 12 and 14 are positioned in relation to one another and in relation to the recombination prism 11 and the hardware optics 16. Of particular advantage here is the fact that the telescopes T focus the displays 9, 12 and 14 through the hardware optics 16, which same hardware optics 16 are provided in the finished projector 1. This makes it possible to take account of tolerances of the hardware optics 16 in the positioning of the displays 9, 12 and 14. Not only are the displays 9, 12 and 14 therefore positioned in a nominal position, but the position of the displays 9, 12 and 14 is specially adjusted to the other optically active elements of the hardware unit 17.

According to a further example of an embodiment of the invention the positioning device 18 also has feedback control means, to which the test image information P-BI emitted by the telescopes T can be fed. The feedback control means are designed for evaluation of the test image information P-BI and for delivering input information to the control means 19. This makes it possible to completely automate the positioning operation and fixing operation of the positioning method described above.

This affords the advantage, for example, that the operator can operate three positioning devices in parallel at staggered intervals. To do this, the operator would only have to perform the loading operation in each instance, and then activate the automatic positioning of the three displays 9, 12 and 14 by the feedback control means. Following the positioning operation and the fixing operation, the operator would only have to remove the finished hardware units 17. This advantageously makes it possible to increase significantly the number of hardware units 17 produced per unit time.

According to a further example of an embodiment of the invention the positioning device positions only one display of a hardware unit in relation to the hardware optics. In this hardware unit the white light is not split into three color beams but lights the one display. By positioning the display in accordance with the positioning method according to the invention a sharp, distortion-free image is obtained.

It may be mentioned that five or seven displays of a hardware unit can also be positioned using a positioning device according to the invention.

It may be mentioned that instead of the LEDs other means of illumination having a low thermal output can also advantageously be used to light the displays during the positioning operation.

It may be mentioned that the term displays is to be broadly interpreted in this context and encompasses all optically active elements which need to be positioned in an apparatus for projecting images. In the same way the recombination prism or the hardware optics could also be positioned using the positioning device according to the invention.

It may be mentioned that the term telescopic optical system is taken to mean all optically active elements which allow the positioning of the displays to be checked by the hardware optics at short range.

It may be mentioned that the test image information P-BI may but need not necessarily be represented by means of monitors. The operator could equally well look through the telescope.

1. A positioning device (18) to position at least a first display (9, 12, 14) of a hardware unit (17), which can be lit by a first color beam (B-FS, G-FS, R-FS, P-FS), in relation to at least one other optically active element (9, 11, 12, 14, 16) of the hardware unit (17), in order to project the image generated by at least one display (9, 12, 14) by projecting a projection beam (PS) that can be emitted by the hardware unit (17) in a plane of projection (P), having holding means (H) for holding at least the first display (9, 12, 14) during a positioning operation and a subsequent operation to fix the positioned display (9, 12, 14), and having optical means (16, T) to which the projection beam (PS) can be fed and which are designed to emit test image information (P-BI) suitable for assessing the positioning of the display (9, 12, 14), and having control means (19) for controlling the holding means (H) in order to adjust the position of the first display (9, 12, 14) in relation to the other optically active elements (9, 11, 12, 14, 16) during the positioning operation, and having fixing means for permanently fixing the positioned first display (9, 12, 14) during the fixing operation, characterized in that the optical means (16, T) contain at least a first telescopic optical system (T), which is designed to focus on individual pixels (PX) in the first display (9, 12, 14).

2. A positioning device (18) as claimed in claim 1, characterized in that as optically active elements the hardware unit (17) contains at least a second display (9, 12, 14) that can be lit by a second color beam (B-FS, G-FS, R-FS, P-FS), hardware optics (16) and a recombination prism (11) designed to recombine the first color beam (B-FS, G-FS, R-FS, P-FS) and the second color beam (B-FS, O-FS, R-FS, P-FS) and to emit the projection beam (PS), and in that in the positioning operation the positioning device (18) is designed to position at least the first display (9, 12, 14) and the second display (9, 12, 14) in relation to one another and in relation to the other optically active elements (11, 16), in order to project the images generated by the two displays (9, 12, 14) congruently in the plane of projection (P).

3. A positioning device (18) as claimed in claim 2, characterized in that the optical means (16, T) also contain a second, a third and a fourth telescopic optical system (T), one telescopic optical system (T) in each case being capable of focusing on pixels (PX) arranged in one of the four corners of the first display (9, 12, 14) and possibly of the second display (9, 12, 14).

4. A positioning device (18) as claimed in claim 2, characterized in that means of illumination (LD-1, LD-2, LD-3) are provided for generating the first and the second color beams (P-FS) and in that the means of illumination take the form of at least one light emitting diode (LD-1, LD-2, LD-3).

5. A positioning device (18) as claimed in claim 1, characterized in that the holding means (H) for the first display (9, 12, 14) have a loading device, in which during a loading operation the first display (9, 12, 14) can be pressed against reference positions by means of positioning pins, in order to position the first display (9, 12, 14) in a starting position for the subsequent positioning operation.

6. A positioning device (18) as claimed in claim 1, characterized in that the holding means (H) have a positioning table, which is designed for adjusting the position of the first display (9, 12, 14) along and about the three spatial axes, the positioning device (18) being designed, when the first display (9, 12, 14) is rotated about one spatial axis, to compensate for a displacement of the displays (9, 12, 14) along the other two spatial axes.

7. A positioning device (18) as claimed in claim 1, characterized in that feedback control means are provided, to which the test image information (P-BI) suitable for assessing the positioning of the displays (9, 12, 14) can be fed from the optical means (16, T) and which are designed to automatically detect control information (SI) for controlling the holding means (H).

8. A positioning device (18) as claimed in claim 1, characterized in that the optical means (16, T) contain the hardware optics (16) of the hardware unit (17), the hardware optics (16) also being contained in a finished projector containing the hardware unit (17).

9. A positioning method for the positioning of at least a first display (9, 12, 14) of a hardware unit (17), which can be lit by first color beam (B-FS, G-FS, R-FS, P-FS), in relation to at least one other optically active element (9, 11, 12, 14, 16) of the hardware unit (17), in order to project the image generated by at least one display (9, 12, 14) by projecting a projection beam (PS) that can be emitted by the hardware unit (17) in a plane of projection (P), said method involving the following stages:
holding at least the first display (9, 12, 14) during a positioning operation and a subsequent operation to fix the positioned display (9, 12, 14);
delivery of the projection beam (PS) to at least one telescopic optical system (T), which is designed to focus on individual pixels (PX) in the first display (9, 12, 14) and which emits test image information (P-BI) suitable for assessing the positioning of the display (9, 12, 14);
controlling the holding means (H), in order to adjust the position of the first display (9, 12, 14) in relation to the other optically active elements (9, 11, 12, 14, 16) during the positioning operation;
permanent fixing of the positioned first display (9, 12, 14) during the fixing operation.

10. A positioning method as claimed in claim 9, characterized in that during a loading operation the first display (9, 12, 14) is pressed against reference positions by means of positioning pins, in order to position the first display (9, 12, 14) in a starting position for the subsequent positioning operation.

11. A positioning method as claimed in claim 9, characterized in that in the positioning, the position of the first display (9, 12, 14) is adjustable along and about the three spatial axes, where a displacement of the display (9, 12, 14) along the other two spatial axes that occurs when rotating the first display (9, 12, 14) about one spatial axis is automatically compensated for.
